(19) United States
(12) Patent Application Publication
(10) Pub. No.: US 2005/0114320 A1
(43) Pub. Date: May 26, 2005

(54) System and method for identifying objects intersecting a search window

(76) Inventor: Jan Kok, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/874,401

(22) Filed: Jun. 23, 2004

Related U.S. Application Data
(60) Provisional application No. 60/524,175, filed on Nov. 21, 2003.

(51) Int. Cl. G06F 17/30

(52) U.S. Cl. 707/3

(57) ABSTRACT

A method of identifying objects intersecting a search window comprises (i) searching each structure associated with each element of a pitch selector; (ii) for each of the structures, searching all subspaces that intersect the search window; and (iii) within each of the subspaces, identifying objects intersecting the search window.

### CROSS-REFERENCE TO RELATED APPLICATIONS

This application claims priority to U.S. Provisional Patent Application No. 60/524,175, entitled, “SYSTEM AND METHOD OF LOCATING NEARBY OBJECTS IN SINGLE AND MULTI-DIMENSIONAL SPACE,” filed Nov. 21, 2003, the disclosure of which is hereby incorporated herein by reference. This application is also related to co-pending U.S. patent application Ser. No. [attorney docket no. 10017127-2], entitled SYSTEM FOR AND METHOD FOR STORING AN N-DIMENSIONAL OBJECT IN A DATA STRUCTURE; and co-pending U.S. patent application Ser. No. [attorney docket no. 100201804-1], entitled A COMPUTER MEMORY FOR STORING AN N-DIMENSIONAL OBJECT, both filed concurrently herewith.

### FIELD OF THE INVENTION

Various embodiments relate generally to the field of data structures, and more particularly to a method for searching for multidimensional objects.

### DESCRIPTION OF RELATED ART

Advances in computer science, including computer hardware, software, and related technologies have led to a proliferation of computer systems and reliance on subsystems to perform a wide range of tasks. While basic numerical calculations performed by computers may be adapted from prior manual calculation methods, more advanced processing often requires detailed analysis of the problem to be solved and application of appropriate structures and processing methodologies. For example, while image recognition processing is a basic function of the human brain, automating the process has been the subject of much research and advanced algorithms. Similarly, more basic relationships between objects and space can be difficult to efficiently define and analyze in a way that may be implemented using a conventional computer. For example, electronic computer-design or “CAD” applications require quickly locating all objects such as conductive “traces” on a printed circuit board or in an integrated circuit design. Using the CAD application, the objects are located in rectangular areas for display on a computer monitor. The user is then allowed to select objects that contain a particular x,y point for further processing such as moving, copying, stretching, deleting, etc. The CAD application must detect objects that touch in order to determine what objects are electrically connected and to apply design rule checks, such as locating objects that are too closely spaced. The CAD application must further identify spatial relationships in estimating the capacitance of a trace, locating nearby traces, and locating empty regions for layout and routing tasks.

In three dimensions, graphics programs may be required to perform ray-tracing by locating objects that intersect rays or cones of light. Similarly, mechanical designs require the locating of objects that are too close or that intersect each other. In chemical research, programs are required to detect nearby atoms in separate molecules, or within a single molecule, allowing determination of how molecules fit together or how they fold up.

In addition to multidimensional problems, there are problems such as scheduling and simulation that require the identification of relationships among objects in a single dimension such as time.

A simplified approach to such problems includes a storage of objects within a matrix or array of the proper dimensionality and exhaustively searching coordinates corresponding to the location of an object to identify overlapping objects or an object containing a given point. This technique, however, quickly becomes computationally infeasible as the size of the space expands and as the dimensionality increases.

Accordingly, there is a need for a method and structure for storing and identifying objects while maintaining their spatial relationships.

### BRIEF SUMMARY OF THE INVENTION

According to at least one embodiment, a method of identifying objects intersecting a search window comprises (i) searching each structure associated with each element of a pitch selector; (ii) for each of the structures, searching all subspaces that intersect the search window; and (iii) within each of the subspaces, identifying objects intersecting the search window.

### BRIEF DESCRIPTION OF THE DRAWINGS

FIG. 1 is a diagram showing a sequence of pitches adapted according to various embodiments to partition one-dimensional space;

FIG. 2 is an illustration of an example embodiment including a set of pitches in two dimensions made up of square subspaces and of example objects accommodated by those subspaces;

FIG. 3 is an illustration of an example embodiment including a two-dimensional object occupying a particular pitch and stripe number defining a subspace;

FIG. 4 is an illustration of an object in a two dimensional space partitioned along a minor dimension of the object into a plurality of subspaces of pitch 1 adapted according to embodiments;

FIG. 5 is an illustration of an object in a two dimensional space partitioned along a minor dimension of the object into a plurality of subspaces of pitch 2 adapted according to embodiments;

FIG. 6 is an illustration of an object in a two dimensional space partitioned along a minor dimension of the object into a plurality of subspaces of pitch 3 adapted according to embodiments;

FIG. 7 is an illustration of an object in a two dimensional space partitioned along a minor dimension of the object into a plurality of subspaces of pitch 4 adapted according to embodiments;

FIG. 8 is an illustration of an object in a two dimensional space partitioned along a minor dimension of the object using a pitch of 4 and partitioned along a major dimension of the object with a pitch of 1 adapted according to embodiments;

FIG. 9 is an illustration of an object in a two dimensional space partitioned along a minor dimension of the object using a pitch of 4 and partitioned along a major dimension of the object with a pitch of 2 adapted according to embodiments;

FIG. 10 is an illustration of an object in a two dimensional space partitioned along a minor dimension of the object using a pitch of 4 and partitioned along a major dimension of the object with a pitch of 3 adapted according to embodiments;

FIG. 11 is an illustration of an object in a two dimensional space partitioned along a minor dimension of the object using a pitch of 4 and partitioned along a major dimension of the object with a pitch of 4 adapted according to embodiments;

FIG. 12 is an illustration of an object in a two dimensional space partitioned along a minor dimension of the object using a pitch of 4 and partitioned along a major dimension of the object with a pitch of 5 adapted according to embodiments;

FIG. 13 is an illustration of a data structure adapted according to embodiments for storing an object;

FIG. 14 is an illustration of an alternative embodiment of a data structure;

FIG. 15 is an example of a data structure operable to store an object as shown in FIGS. 2 and 3 according to various embodiments;

FIG. 16 is a block diagram that illustrates a method adapted according to embodiments for storing an object in a given space;

FIG. 17 is a block diagram that illustrates a method according to various embodiments for searching a data structure to identify objects stored in the structure, including a designated test point; and

FIG. 18 is a block diagram illustrating a method adapted according to various embodiments for identifying objects stored in a data structure contained within a rectangle.

### DETAILED DESCRIPTION

Glossary

Unless otherwise noted, terms and phrases used herein are defined as follows. “Object” refers to a representation in computer memory of a (typically physical) object that a user wants to manage and classify according to location in an information or physical space.
“Dimension” refers to a number and name associated with a given set of independent variables, e.g., x, y, z, t.
“Coordinate” refers to the position of a point in a specified dimension. For the purpose of describing embodiments, unless otherwise specified, coordinates are assumed to be integer values.
“Floor” is a mathematical function which returns the greatest integer less than or equal to the argument and is represented by an argument enclosed by brackets closed only at the bottoms, i.e., “└ ┘”.
“Ceiling” is a mathematical function which returns the smallest integer greater than or equal to the argument and is represented by an argument enclosed by brackets closed only at their tops, i.e., “┌ ┐”.
“Lower extent” is the floor of the minimum-valued coordinate occupied by an object in a specified dimension.
“Upper extent” is the ceiling of the maximum-valued coordinate occupied by an object in a specified dimension.
“Extents” include the lower extent and the upper extent of an object in a specified dimension, or (depending on context) all the lower extents and upper extents of an object.
“Expanse” of an object is the upper extent minus the lower extent of an object in a specified dimension.
“Space” or “workspace” refers to an entire single- or multidimensional coordinate space which may contain one or more objects. The terms are interchangeable; however, “workspace” is sometimes used to emphasize the concept of the full coordinate space, in contrast with a subspace.
“Subspace” refers to a portion of a space restricted in one or more dimensions such as points, lines, planes, stripes, french fries, slabs, etc.
“Pitch” is a partition of a space into subspaces that are uniform in size except for the subspaces at the extreme ends of the ranges of the coordinates along which the subspaces are “stacked”.
“Scale” is a set of pitches, wherein all of the pitches are partitions of the same space, but each pitch partitions the space in a different way.

Some additional terms are defined later.

Introduction

Various embodiments include a data structure and algorithms for storing computer representations of (typically) physical objects that are considered to occupy a bounded region in a single- or multidimensional workspace. The data structure allows storage of the objects according to their size and location in space, so that the objects can be quickly stored, and then objects that are at or near a given point in space, or overlap a given region of space, can be quickly searched for and found. Empty regions of space within given regions may also be found.

The data structure is based on the concept of dividing space up into many regions, called subspaces. Objects are “stored” in (associated with) subspaces such that each object is contained entirely within its associated subspace. The subspaces may be line intervals, rectangles, rectangular parallelepipeds, etc., depending on the number of dimensions (i.e., “dimensionality”) that the objects are considered to have.

For example, in a two-dimensional space (i.e., a dimensionality of 2), the space is divided up into rectangles. The space is partitioned in many different ways so that there are a variety of rectangles of different sizes and aspect ratios that cover any point or region of the space. Thus, there are a variety of rectangles available for storing a given object. An object is stored in the best-fitting available rectangle.

In at least one embodiment, for a two-dimensional space, all the rectangles that cover the space have sides that are powers of 2 times a basic grid unit. The boundaries of rectangles of different sizes are (as much as possible) offset from each other so that the boundaries tend not to coincide. This scheme of sizes and offsets may allow objects to be stored in rectangles that are not much larger (within a factor of 8 in linear dimension) than the objects.

Alternatively, multiple rectangles of the same size and shape may be provided overlapping any given point in the space, in order to provide better fits for the objects. The multitude of rectangles are indexed in a regular fashion such that, for any given object to be stored, the rectangle which provides the best fit can be quickly located or instantiated in memory. Furthermore, for any given point in space, or any given region, such embodiments may allow objects that are at or near the given point or region to be quickly located.

Various embodiments employ a data structure implemented with sparse arrays, so that memory is allocated only for those rectangles (or other types of subspaces) that contain objects. A full description of a suitable data structure efficiently implementing sparse arrays is the “hybrid tree” structure described in U.S. patent application Ser. No. 09/874,654 entitled “SYSTEM FOR AND METHOD OF EFFICIENT, EXPANDABLE STORAGE AND RETRIEVAL OF SMALL DATASETS,” filed Jun. 4, 2001; U.S. patent application Ser. No. 09/874,586 entitled “SYSTEM AND METHOD OF PROVIDING A CACHE-EFFICIENT, HYBRID, COMPRESSED DIGITAL TREE WITH WIDE DYNAMIC RANGES AND SIMPLE INTERFACE REQUIRING NO CONFIGURATION OR TUNING,” filed Jun. 4, 2001; U.S. patent application Ser. No. 09/874,468 entitled “SYSTEM AND METHOD FOR DATA COMPRESSION IN A ‘VALUELESS’ DIGITAL TREE REPRESENTING A BITSET,” filed Jun. 4, 2001; U.S. patent application Ser. No. 09/874,788 entitled “SYSTEM FOR AND METHOD OF CACHE-EFFICIENT DIGITAL TREE WITH RICH POINTERS,” filed Jun. 4, 2001; and U.S. patent application Ser. No. 09/457,164, entitled “A FAST EFFICIENT ADAPTIVE, HYBRID TREE,” filed Dec. 8, 1999, all of which are incorporated herein by reference in their entireties.

The following sections describe in more detail:
schemes for dividing a workspace into subspaces
data structures used to organize and represent the subspaces and to provide pointers to objects, and

methods of using the data structures to store and locate objects.

Scales and Pitches in One-Dimensional Space

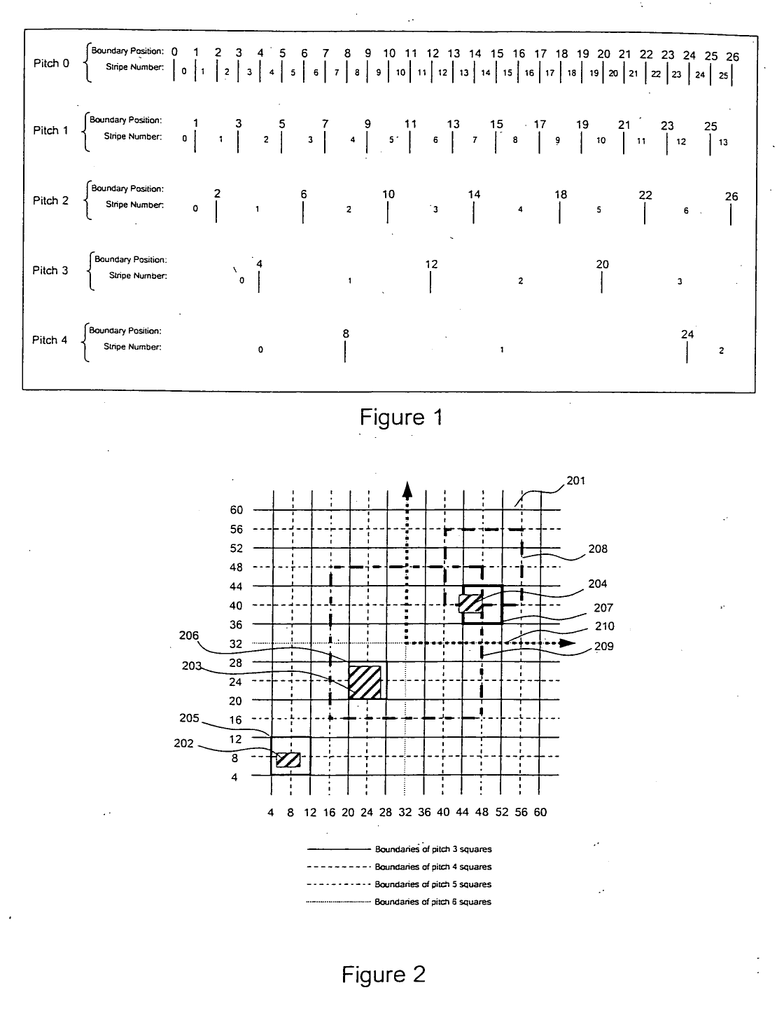

FIG. 1 is a diagram showing a sequence of pitches adapted according to various embodiments to partition one-dimensional space. In the present example, the pitch number refers to the base-two log (log₂) of the basic increment amount, i.e., the expanse of the subspace in the dimension partitioned by the pitch. Thus, a pitch value of zero as shown in the top scale of FIG. 1 defines a partitioning so as to divide a space into a plurality of subspaces of expanse 2⁰=1 unit in the direction of the partitioning. The present embodiment uses integer numbering so that, unlike subsequent pitches, pitch zero does not include any offset so that the first subspace from unit 0 through, but not including, unit 1 herein designated as stripe zero, has the whole expanse defined by 2^{pitch number}=1 as do the subsequent stripes . . . (n−2), as does the final stripe (n−1). As will be seen, subsequent pitches include an offset.

Pitch 1 defines a partition wherein all but the first and last subspaces have an expanse of 2¹=2 units. However, so that subsequent partitionings do not include boundaries coincident with partitionings defined by the other pitches, an initial subspace or “stripe 0” has an expanse equal to one half that of the intermediate subspaces, i.e., 2^{(pitch number-1)}. In the present case of pitch 1, stripe zero has an expanse of 2⁽¹⁻¹⁾=1, extending from zero through, but not including, one. Similarly, the final subspace, i.e., stripe n where n=└space expanse/2^{(Pitch number)}┘ also has an expanse equal to 2^{(pitch number-1)}. The remaining subspaces each have the full expanse defined by 2^{(pitch number)}, extending from and including the lower partition up to, but not including, the upper partition boundary. Thus, referring to FIG. 1, pitch number 1 applied to a space having an extent of 26 units partitions the space into 14 subspaces, the first and the final subspaces having an expanse of 2⁽¹⁻¹⁾=1 unit and the intermediate subspaces, i.e., stripes {1-12} have expanses of 2¹=2 units. Similarly, pitch number 2 defines a first subspace starting at zero and extending up through, but not including, a partition boundary at unit 2. Subsequent partition boundaries are spaced at 4 units. Likewise, pitch number 3 defines a first subspace having an expanse of four (2⁽³⁻¹⁾, subsequent subspaces (other than any final subspace) having expanses of 8, while pitch number four defines an initial subspace having an expanse of 8, subsequent subspace having expanses of 16.

More formally, a given pitch number of 1 or greater partitions a space at boundaries found by 2^{(pitch number-1)}+(n−1) 2^{(pitch number)} to (but not including) 2^{(pitch number-1)}+(n)2^{(pitch number)} where n represents the stripe number.

Scales and Pitches in Two-Dimensional Space Using Squares

FIG. 2 is an illustration of an example embodiment including a set of pitches in two dimensions made up of square subspaces and of example objects accommodated by those subspaces. In FIG. 2, two dimensional field 201 extends 64 units in the x and y dimensions, and contains objects 202, 203, and 204. The space is shown divided by boundary lines representing pitch 3, 4, 5, and 6 squares. As previously described, except for the initial partitioning, pitch 3 squares have boundaries spaced 2³=8 units as shown by the solid horizontal and vertical lines. Note also that the pitch 3 boundaries begin with boundaries x=4 and y=4. Pitch 4 squares are defined by boundaries located at x={8, 24, 40, and 56} and y={8, 24, 40, and 56}. Also shown are boundaries for pitch 5 and pitch 6 squares. Note that none of the boundaries are coincident, such that any one particular object will necessarily fit entirely within a square of pitch no more than two more than the maximum expanse of the object. That is, even if an object is located on a boundary defining a size square minimally able to contain the object, it will be necessary to advance no more than two more pitches in square size until a suitable square entirely containing the object will be identified.

For example, object 202 may be defined by two ordered pairs of coordinates defining its lower left and upper right corners. Thus, object 202 may be defined by the ordered pairs of x,y coordinates of {5,6}; {10,9}. In this case, it can be seen that object 202 has a maximum extent of five units in the x direction and therefore is too big to fit into a square having a pitch less than three, i.e., having a side length of at least 8, the next smaller pitch of 2 having a side length of only 4. (Note, because the upper boundary defining each square is excluded from the subspace defined by the square, an object may go up to, but may not include, the upper boundary.) As can be seen in FIG. 2, object 202 falls entirely within square 205 of pitch 3. Consistent with the previously described naming designation for stripes, we may identify square 205 by the ordered pair of striped numbers defining the square. Thus, square 205 is pitch 3, square {1,1 } . Similarly, object 203 is contained within square 206 of pitch 3, square {3,3}.

Object 204 is defined by the set of ordered pairs {43,38}; {48,42}. Thus, object 204 has a “major dimension”, i.e., a maximum expanse in the x direction, of five units. Accordingly, the minimum sized square that could contain such a sized object would be a pitch 3 square having a side length of 8 units. However, as shown in FIG. 2, it can be seen that object 204 crosses on the boundary of pitch 3 square 207 and, therefore, includes the adjacent pitch 3 square to the left (not labeled). The next larger pitch square has sides of length 16, one of which is depicted as square 208. Again, however, object 204 falls on a lower boundary of square 208 making it necessary to investigate the next larger pitch square 209. In this case, we see that, while at first glance, object 204 appears to fit entirely within square 209, the right or “upper extent” of object 204 in the x dimension coincides with the upper boundary of square 209. Since the upper boundary is not included within the subspace, we advance to the next larger pitch number equal to 6 within which to place object 204. In this case, object 204 is contained entirely within pitch 6 box 1,1, the lower left quadrant of that square shown by the dotted lines of FIG. 2 and depicted by bolded arrows.

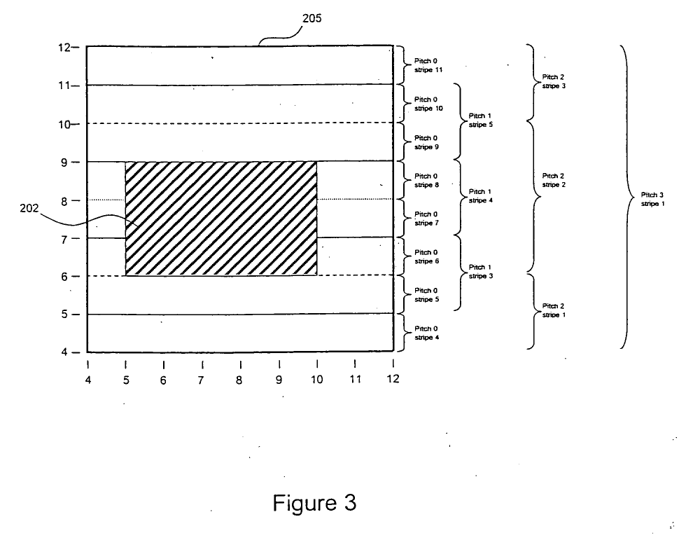

FIG. 3 is an illustration of an example embodiment including a two-dimensional object occupying a particular pitch and stripe number defining a subspace. FIG. 3 shows further details of object 202 as it is positioned within pitch 3 square 1,1, i.e., square 205. The brackets at the right of the figure show partitioning of the subspace by boundaries extending parallel to the x direction spaced in the y direction to define stripes 4-11 of pitch 0, i.e., expanse=1. Similarly, pitch 1 stripes 3, 4, and 5 partition the subspace defined by square 205. Note that while object 202 fits entirely within pitch 2 stripe 2 in its minor dimension, i.e., in the y dimension, it is necessary to go to pitch 3 stripe 1 to accommodate the width of object 202, i.e., its major dimension in the x direction. This is to be expected since this major dimension resulted in the selection of pitch 3 square 1,1.

Scales and Pitches in Two-Dimensional Space Using Rectangles

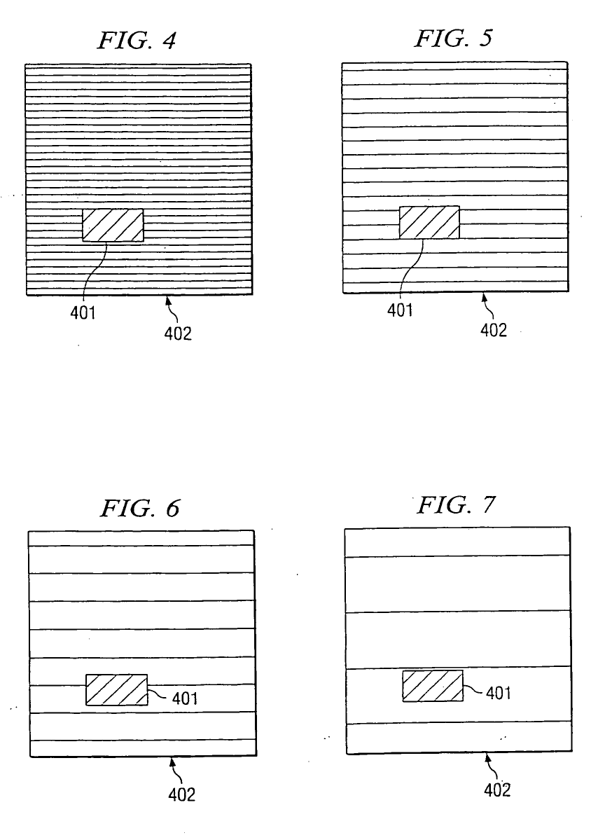

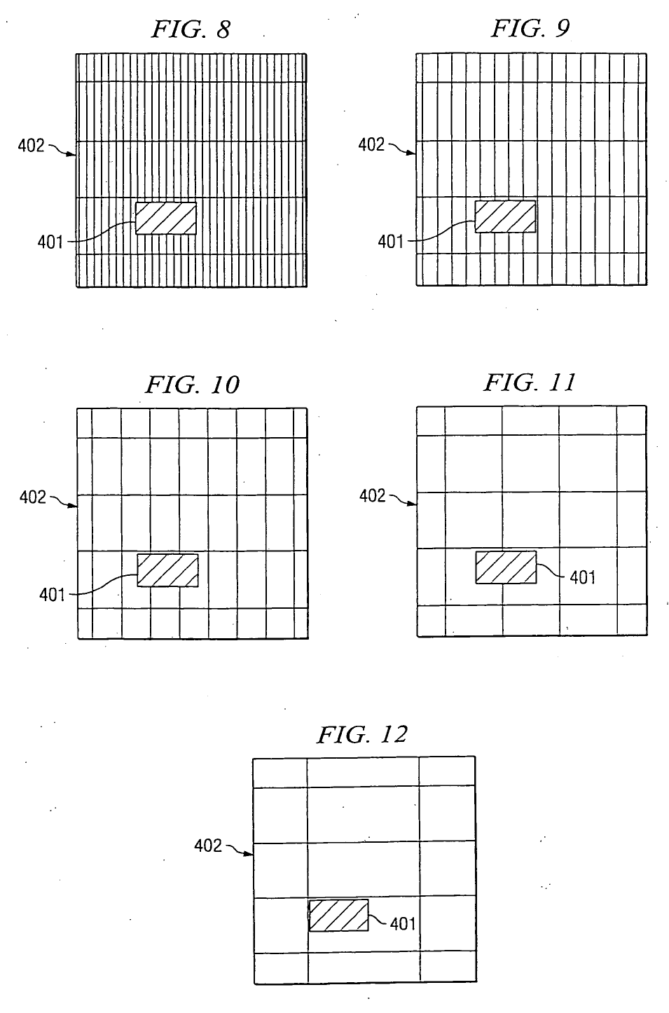

FIGS. 4-12, taken together, illustrate a sequence of identification of an appropriate subspace to contain a representative object adapted according to various embodiments. In this technique, a set of intersecting stripes are identified to define a contained subspace beginning with a minor dimension of the object, i.e., without first identifying a suitable square. In particular, referring to FIG. 4, object 401 is the rectangle {17, 14}; {34,23} within a space {0,0}; {63,63} 402. In FIG. 4, space 402 is partitioned into a plurality of subspaces in the form of horizontal stripes of pitch 1 such that the extreme bottom and top most stripes each have a height of 1 while the intermediate stripes each have a height of 2 units. Again, the naming convention used herein designates the bottom-most stripe of FIG. 1 as stripe 0, the stripe number being incremented for each subsequent stripe above. Thus, object 401 spans pitch 2 stripes 7-12 (since the top of object 401 is coincident with the lower boundary line for stripe 12, stripe 12 is included in the range). Referring to FIG. 5, pitch 2 stripes 0-16 are shown partitioning space 402 into 17 subspaces or stripes. Since object 401 has a minor dimension of 9 units, it is obvious that the object cannot fit into any one stripe in the pitch 2 and pitch 3 stripes shown in FIGS. 5 and 6. However, with reference to FIG. 7, object 401 may be contained entirely within pitch 4 stripe 1. Thus, as shown in FIGS. 4-7, a first step of identifying a subspace containing an object according to at least one embodiment includes identifying a suitable pitch and stripe number containing an object in a minor dimension of the object.

In this example embodiment, once the appropriate boundaries are identified with which to contain an object in its minor dimension (that is, the dimension of its smallest expanse), a similar process is used in the remaining dimension to increase dimensionality of the object, that is, in order of increasing object expanse directions. Thus, as shown in FIGS. 8-11, space 402 is partitioned in the x direction into a plurality of vertical stripes until, as shown in FIG. 12, object 401 is contained in its major dimension within a suitable vertical stripe, in this case pitch 5 stripe 1. Note that when defining subspaces using rectangles, as opposed to using squares in the previous example, those embodiments may require defining both a pitch and stripe number for each of the dimensions. Thus, a naming convention for a subspace may include designating ordered pairs of pitch numbers and stripe numbers for each of the dimensions. Thus, in FIG. 12, object 401 is contained within space {5,1}; {4,1} meaning that, in the x direction, the object fits in pitch 5, stripe 1 and in the y direction in pitch 4, stripe 1.

Data Structure Building Blocks

A subspace selector is a data structure that can be used directly for storing objects according to expanse and location, or it can be used as a building block for more complex data structures that can be used for storing of objects according to expanses and location. The purpose of a subspace selector is to allow storing objects in subspaces of a “selector input space” which may be the full user space or may be some subspace of the full user space.

The embodiments in this example will focus on four variations of subspace selectors; however, any kind of appropriate subspace selector may be employed by alternate embodiments. The simplest variation is described first.

The first variation of a subspace selector (referred to as “basic subspace selector”) adapted according to embodiments is a tree in which the root node is a sparse array (referred to as a “pitch selector”), and the next level of nodes are sparse arrays (referred to as “subspace arrays”). The elements of a pitch selector are pointers to subspace arrays. Each subspace array within a subspace selector represents a unique pitch, that is, a unique partition of the selector input space. The elements of subspace arrays are pointers used to represent individual subspaces. The pointers point to objects or to other subspace selectors, according to the role of the subspace selector in higher-level compositions of data structures. The subspace selectors may be implemented as multiple levels of sparse arrays, for example to allow for convenient indexing in multiple dimensions.

The second variation of a subspace selector (referred to as a “directional subspace selector”) adapted according to embodiments is a tree whose root node is an array (referred to as the “orientation selector”), the elements of which point to basic subspace selectors. The elements of the orientation selector array represent different orientations of objects, for example, with two-dimensional objects, one branch could be for objects whose expanse in the x direction is greater than their expanse in the y direction, and another branch could be for objects whose expanse in the y direction is greater than or equal to their expanse in the x direction.

The third variation adapted according to embodiments is a basic subspace selector with orientation selectors inserted between the root and second level nodes. A fourth variation adapted according to embodiments has two levels of orientation selectors, a combination of type 2 and 3.

A single subspace selector may be used to store objects, or a plurality of subspace selectors (of same or different types) may be composed to form multilevel structures that may be efficient for storing types of objects.

Data Structures for Storing and Locating Objects

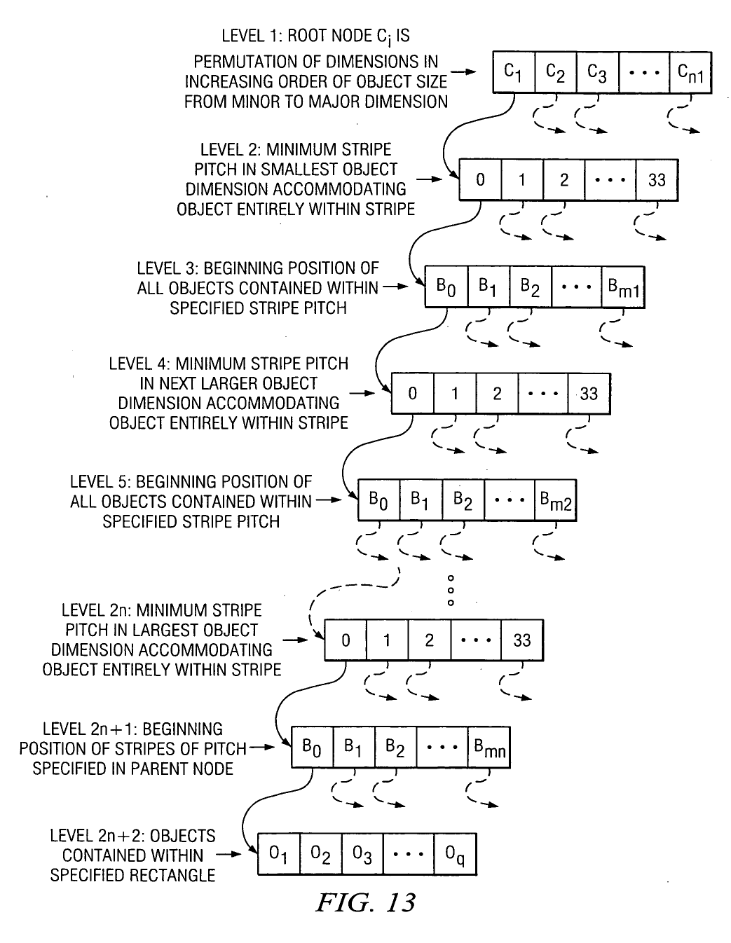

FIG. 13 is an illustration of a data structure adapted according to embodiments for storing an object. In FIG. 13, a left most path through a tree structure is shown, the tree including nodes at levels increasing from top toward bottom of the figure. The dotted arrows point to similar structures (if any) forming other subtrees. Thus, the upper-most level one root node includes references to subtrees corresponding to various permutations of the space dimensions in order of object size from minor to major dimension. For example, in a 3-dimensional space having axes labeled x,y,z, there are 6 potential permutations, i.e., {x,y,z}; {x,z,y}; {y,x,z}; {y,z,x}; {z,x,y}; {z,y,x} ordered from most minor dimension to major dimension. Accordingly, in FIG. 13, C₁ references a subtree containing all objects having a designated order of dimensionality, e.g., {x,y,z} for a 3-dimensional space.

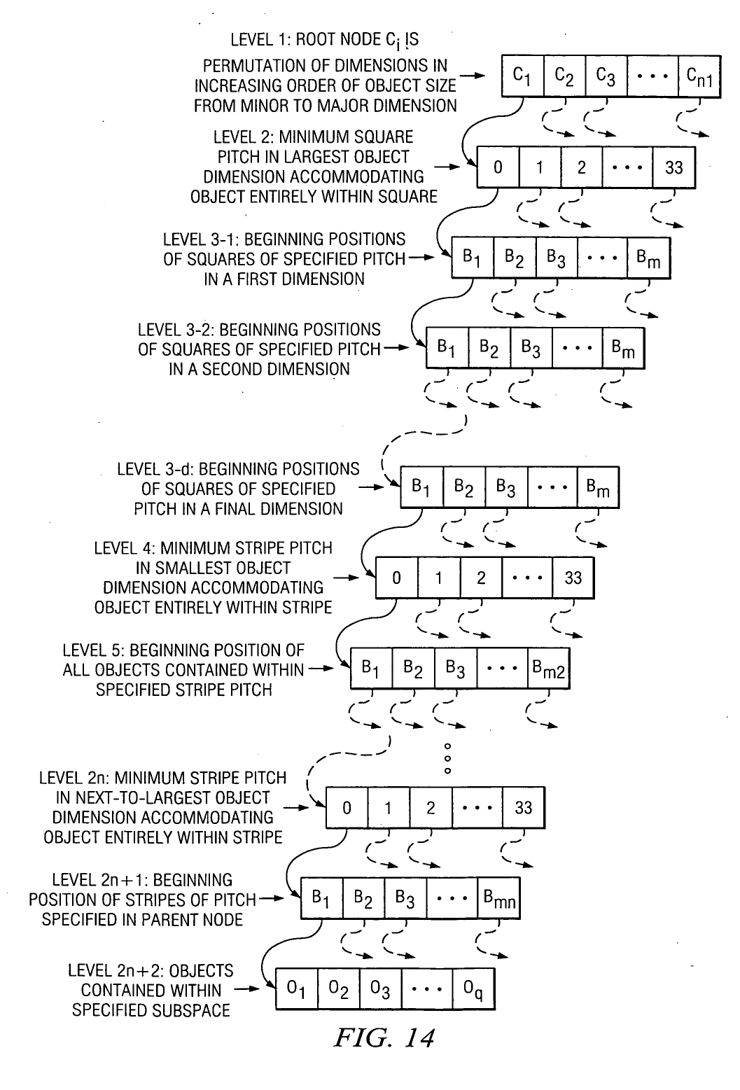

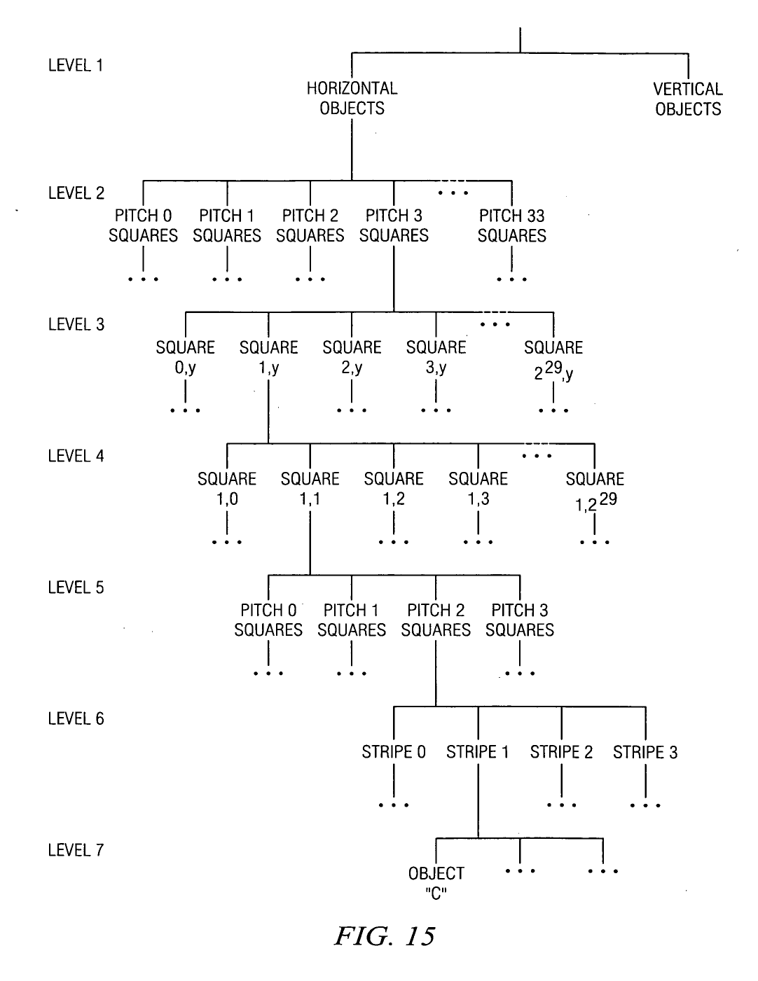

Level 2 of the structure is shown as an array of references to subtrees corresponding to a minimum stripe pitch in the smallest object dimension accommodating the object entirely within the stripe. As previously described, this minimum stripe pitch must take into account not only the width of the stripe, but the position of the object with reference to predetermined stripe boundaries partitioning the space. In the case of stripes, it may be necessary to advance to two higher levels of stripe expanse over the minimum expanse in which an object might otherwise fit to identify a stripe properly aligned to accommodate the object. Though FIG. 13 in levels 2, 4, and 2n (and also FIGS. 14 and 15) shows 33 as a maximum pitch, such maximum is not an absolute maximum, as alternative embodiments may accommodate larger objects appropriately. Once this pitch is determined, then the appropriate reference is taken to a subtree at level 3, which includes all stripes of the selected pitch, level 3 depicted as an array of starting positions, i.e., stripe numbers, for the given stripe pitch. Thus, the combination of level 2 and level 3 constitute a pitch selector, level 2, selecting a particular stripe pitch and level 3 selecting an appropriate stripe number defining a subspace containing a minor direction of an object to be stored in the data structure. This process of defining stripes for each of the dimensions of the space is performed in a like manner in increasing dimensionality of the object. Thus, level 4 defines a minimum stripe pitch in the next larger object dimension accommodating the object entirely within the stripe, while level 5 includes a beginning position for the stripe, again the stripe number. Finally, as shown in FIG. 13, at a level 2n the minimum stripe pitch in the largest object dimension is designed, the beginning position of the stripe specified at level 2n+1. At this position of the structure, a complete set of constraints in the form of a number of stripes corresponding to the dimensionality of the space have been defined, thereby defining a closed subspace. That is, in a two dimensional space, a pair of orthogonal intersecting stripes define a rectangular subspace, while in a three dimensional space, three pair of mutually orthogonal planes intersect to define a parallelepiped, in this case, a rectangular solid.

After traversing the tree-type data structure through the series of subspace selectors, as described, an appropriate completely bound subspace is defined. As shown in FIG. 13, a lowest level 2n+2 of the tree includes a list of objects contained within the defined subspace.

FIG. 13 illustrates at least one embodiment in which objects are first categorized by order of dimensionality from minor to major dimension and then are stored in a subspace defined by a series of subspace selectors, each subspace selector designating both a pitch and start or stripe number constraining the subspace by specified end points (one dimension), parallel lines (two dimension), parallel planes (three dimension), etc.

FIG. 14 is an illustration of an alternative embodiment of a data structure. This data structure includes an initial partitioning of a space into squares or similar symmetric structures depending on the dimensionality of the space as previously described in connection with FIGS. 2 and 3. This initial step of identifying a square of an appropriate pitch and starting position may be particularly well suited to accommodate objects wherein there is a mix of objects elongated predominantly in a direction of the axis defining the dimensions. For example, in a two-dimension integrated circuit or printed circuit layout, “wrong-way metal” may adversely affect data storage using the structure in connection with FIG. 13. Accordingly, inserting an initial subspace selector designating an appropriate square may ameliorate these problems in such embodiments.

A Method for Storing Objects in the Data Structure

For two-dimensional space, a method according to at least one embodiment for inserting objects into the data structure works as follows: the extent of the object in each dimension is determined (i.e., the minimum and maximum coordinates occupied by the object in each dimension). The direction (“x” or “y”) of the smaller extent is referred to as the “minor” direction or dimension, and the other as the “major” direction or dimension. Depending on which direction is the minor direction, one of two instances of a data structure is selected for storing the object (e.g., one instance for storing “horizontal” objects, and the other for storing “vertical” objects). The extent in the minor direction, in combination with the lower and upper bound of the object in the minor direction, are used to determine the best-fit conceptual rectangles that can contain the object in the minor direction. The size of the conceptual rectangle in the minor direction is used to look up a structure holding all rectangles of that size in that direction. The lower bound of the conceptual rectangle is then used to find a structure holding all the rectangles with that lower bound in the minor direction. The extent, lower bound and upper bound of the object in the major direction are then used to find the best-fit conceptual rectangle for the object. The extent of the conceptual rectangle in the major direction is used to find a structure containing all the conceptual rectangles of that size in the major direction (but of one specific size and location in the minor direction). The lower bound of the conceptual rectangle in the major direction is then used to locate the specific conceptual rectangle that provides that best fit for the object. At each lookup step in the foregoing description, sparse arrays are created as needed, and cells are created in the sparse arrays as needed, to ultimately provide memory cells to point to a collection of objects that have a best fit in particular conceptual rectangles. So at this point, a (possibly null) pointer exists in memory and has been located, that points to the collection of objects that have been placed in the conceptual rectangle that provides the best fit to the object being stored. The object to be stored is added to that collection. Though this example illustrates inserting two-dimensional objects into a data structure, objects of greater number of dimensions may be accommodated by a similar method wherein extra steps are added and extra tree branches are added such that the upper bounds, lower bounds, and extents of those objects may be used to find the best fit conceptual n-dimensional subspaces for those objects, and those objects may then be inserted into the data structure.

Locating Objects in the Data Structure

There are several possible criteria for looking up objects by location. For example, objects that contain a given point in space may be located, or objects that overlap a given n-dimensional subspace may be searched through all conceptual n-dimensional subspaces that can potentially contain an object meeting the criteria. Because of the use of sparse arrays, the number of conceptual n-dimensional subspaces that are actually instantiated in memory and need to be inspected is limited. The use of a suitable construct of sparse arrays also allows ranges of indexes to be quickly searched for non-empty elements. For example, according to at least one embodiment, the hybrid tree data structure (described in the previously cited and incorporated U.S. patent applications) is employed to efficiently store and search the resultant sparse data sets representing objects in large spaces.

In addition to finding objects, various embodiments may also be operable to locate empty regions of space by searching through the data structures looking for empty regions rather than for objects.

Referring to FIG. 14, an initial selection is made at level 1 to sort objects based on the dimensions of increasing order of expanse from minor to major dimensions. As previously described, level 1 as shown in FIG. 14 includes an array of pointers or redirections to subtrees for each of the possible permutations of the space dimensionality. However, rather than initially partitioning the space into stripes, an initial subspace selector identifies a square pitch in the largest object dimension which will accommodate the object entirely within the square. Note that, although the term square is used herein, the actual geometry of the subspace would correspond with the dimensionality of the space such that an appropriate cube pitch is selected in a three dimension case, an appropriate hyper-cube for four dimensions, etc. Multiple level 3's (i.e., 3−n) are then pointed to, each level designating a value in one of the dimensions as a start point for the square, cube, hyper-cube, etc. Thus, level 3-1 as depicted in FIG. 14 includes a scalar value indicating a position of the square of the specified pitch in a first dimension, while level 3-2 includes a value designating a position of the square in a second one of the dimensions. Accordingly, multiple level 3's are used to designate an ordered set of values specifying the location of the square of designated pitch indicated in level 2.

In this example, once an appropriate square is identified by levels 2 and 3, a stripe accommodating the smallest object dimension is identified and used to traverse level 4 of the structure. As before, level 4 provides stripe pitch selection with the subsequent level 5 providing beginning position of the specified pitch stripe, and together levels 4 and 5 constitute a subspace selector. Thus, an appropriate series of subspace selectors in the form of (i) stripe pitch nodes, and (ii) beginning position nodes are provided until all of the dimensions of the space are accommodated. Because the largest dimension of the object in this example was already used in selection of the square subspace partitioning in levels 2 and 3, the final level of stripe definition at levels 2n and 2n+1 address only the next-to-largest object dimension. Level 2n+2 include nodes of lists of objects contained within the now fully defined subspace.

FIG. 15 is an example of a data structure operable to store an object as shown in FIGS. 2 and 3 according to various embodiments. In this example, object 202 has a horizontal expanse that is greater than its vertical expanse, and is therefore designated as being a horizontal object at level 1. At level 2, object 202 is identified as contained within a square of pitch 3, therefore, traversing through the pitch 3 squares pointer to level 3. Level 3 is, in turn, traversed by identifying the x value associated with the pitch 3 square. As previously described, as the starting locations are designated as indices from zero through some maximum number, the x value 1 is identified at level 3 and the appropriate subtree taken to level 4. The node at level 4 likewise is traversed by identifying a y start value for square 205 (FIG. 2) to arrive at level 5 of the data structure. Once at level five, the pitch accommodating the minor dimension of the object, i.e., the y direction, is identified and, as shown in FIG. 3, corresponds to a stripe of pitch 2, stripe 2. Accordingly, levels 5 and 6 are traversed arriving at level 7 where object 202 is stored with other objects contained within the specified subspace.

Three types of subspace selector mechanisms described herein include: 1) an orientation selector for ordering a dimensionality of the object as in level 1 of FIGS. 13 and 14; 2) a symmetric or square subspace selector as described in connection with levels 2 and 3 of FIG. 14; and 3) a rectangular or stripe-type space selector including alternating sequences of pitch nodes followed by stripe designation nodes, as in FIG. 15. In addition to the data structure depicted in FIGS. 13-15, other arrangements of subspace selectors may be used. Accordingly, a suitable structure may include any number of these mechanisms in various combinations appropriate to the geometry of the objects to be stored.

In various embodiments, a characteristic of data structures is that they may be very sparse. Those embodiments may require a suitable construct be used to store the structure without allocating memory to unused nodes and branches. Therefore, at least one embodiment relies on a particularly efficient hybrid tree structure described in the previously cited and incorporated patent applications.

Storing an Object—Details

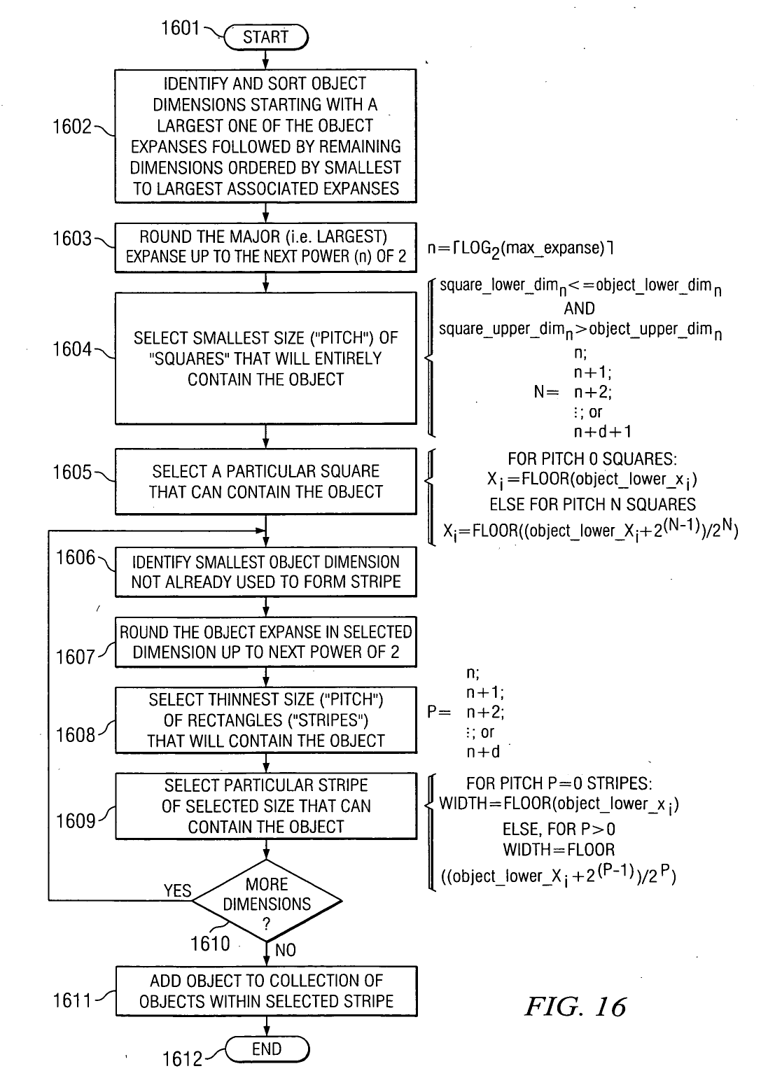

FIG. 16 is a block diagram that illustrates a method adapted according to embodiments for storing an object in a given space. Starting at block 1601, at block 1602 objects are identified and sorted by their dimensionality starting with the largest one of the object expanses followed by remaining dimensions ordered by smallest to largest associated expanses. At block 1603 the major expanse is rounded up to the next power (n) of 2 so as so identify a minimum pitch size capable of accommodating the object. At block 1604 the smaller size of squares that will entirely contain the object is selected. As previously described, it may be necessary to select a higher pitch value to avoid an object crossing a boundary. Thus, the following conditions must be satisfied:
square_lower_dimₙ<=object_{—lower}_dim,
AND
square_upper_dimₙ>object_upper_dimₙ.

For a square, not only must the minimum pitch of size n be investigated, but pitches up to and including n+d+1 may be needed to ensure that the object falls entirely within a square subspace.

At block 1605, a particular square is selected that can contain the object. For pitch zero squares, the starting point in each dimension is equal to Xᵢ=floor (object_lower_xᵢ) whereas for pitch one and above, the starting point in each dimension is equal to Xᵢ=floor ((object_lower_xᵢ+2^{(N-1)}/2^{N}).

Once the appropriate square has been selected at blocks 1603-1605, blocks 1606-1610 are iterated for each of the remaining dimensions. Thus, at block 1606, the smallest object dimension not already used to form a stripe is identified. The object expanse is rounded in the selected dimension up to the next power 2 at block 1607 and, at block 1608, the thinnest sized (“pitch”) of rectangles (“stripes”) that will contain the object is selected. As before, this may require that a pitch of up to n+d be used. At block 1609 the particular stripe of the selected size that can contain the object is selected, such that the lower extent of the object does not go below the floor of the space and the upper extent of the object is below the floor of the space above. Block 1610 loops back to address each dimension in-turn sequence. Otherwise, block 1610 is exited to the right when all dimensions have been accommodated thereby fully identifying a subspace for storage of the object. At block 1611 the object is added to the collection of objects within the selected stripe, the method ending at block 1612.

Locating an Object at a Given Test Point

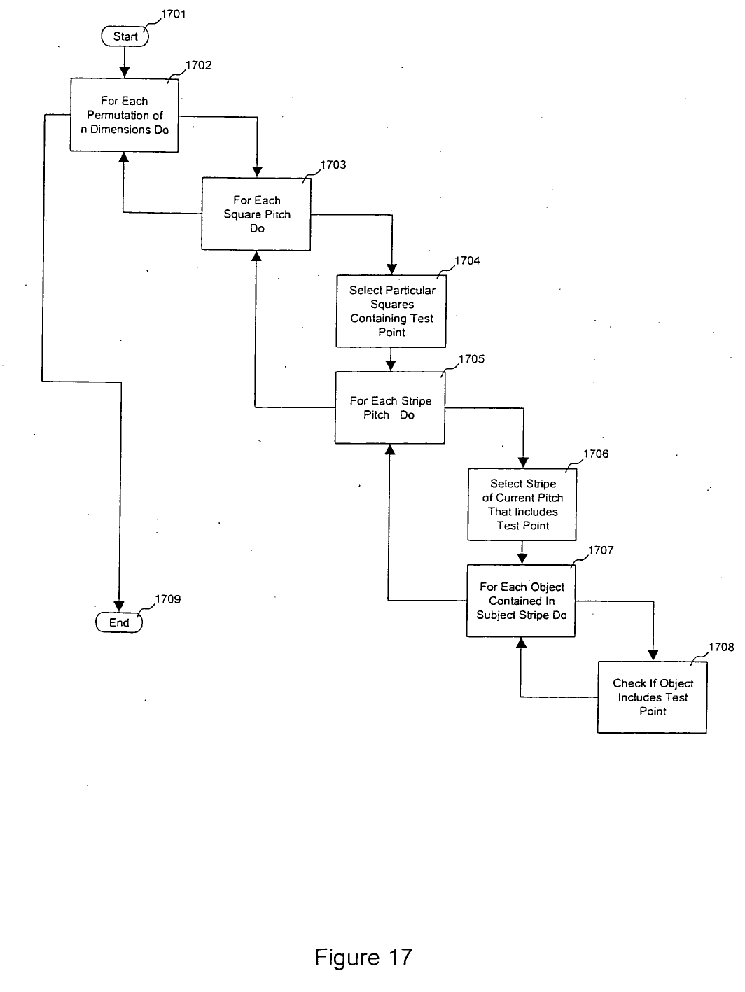

FIG. 17 is a block diagram that illustrates a method according to various embodiments for searching a data structure to identify objects stored in the structure, including a designated test point. The method includes a nested loop structure for traversing the data structure. In the example of FIG. 17, a particular type of hierarchical data structure according to various embodiments is assumed, the method being adaptable to other data structures and, in particular, data structures in which other combinations and types of subspace selectors are used. Thus, while FIG. 17 illustrates the traversal of a data structure having a dimensionality selector followed by a symmetric space (e.g., square) selector followed by a plurality of slice or stripe-type selectors, other subspace selection mechanisms and combinations thereof may be accommodated.

Starting at block 1701, an outer loop beginning at block 1702 provides for execution of the remaining processes 1703-1708 for each of the permutations of n dimensions of the storage space. That is, for a two dimensional space, block 1702 would cause the execution of block 1703 once for each of length and width. Block 1703, in turn, initiates multiple execution of the subsequent steps as defined by each subsequent loop, progressing from outermost to innermost loop. In the case of two dimensions, block 1703 is executed twice, once for a subtree storing horizontally oriented objects and once for a subtree storing vertically oriented objects. In a three dimension space, block 1702 causes six executions of block 1703 to the extent that each of the six possible subtrees associated with respective permutations of the three dimensions (e.g., x, y, and z) are not empty or null.

Block 1703, in turn, steps through each subtree associated with a particular square pitch value. Particular squares of the selected pitch containing the test point are identified at block 1704 and, to the extent the respective node references further subtrees, block 1705 initiates an iteration for each stripe pitch referenced by the current square. Thus, at block 1706, for each stripe pitch, a stripe including the designated test point is identified so that, at block 1707 a list of objects contained within the stripe is identified. At block 1708 each object within the list associated with the selected subspace is tested to determine if it includes the designated test point. The method terminates at block 1709 after traversal of the data structure.

Locating Objects Overlapping a Test Rectangle

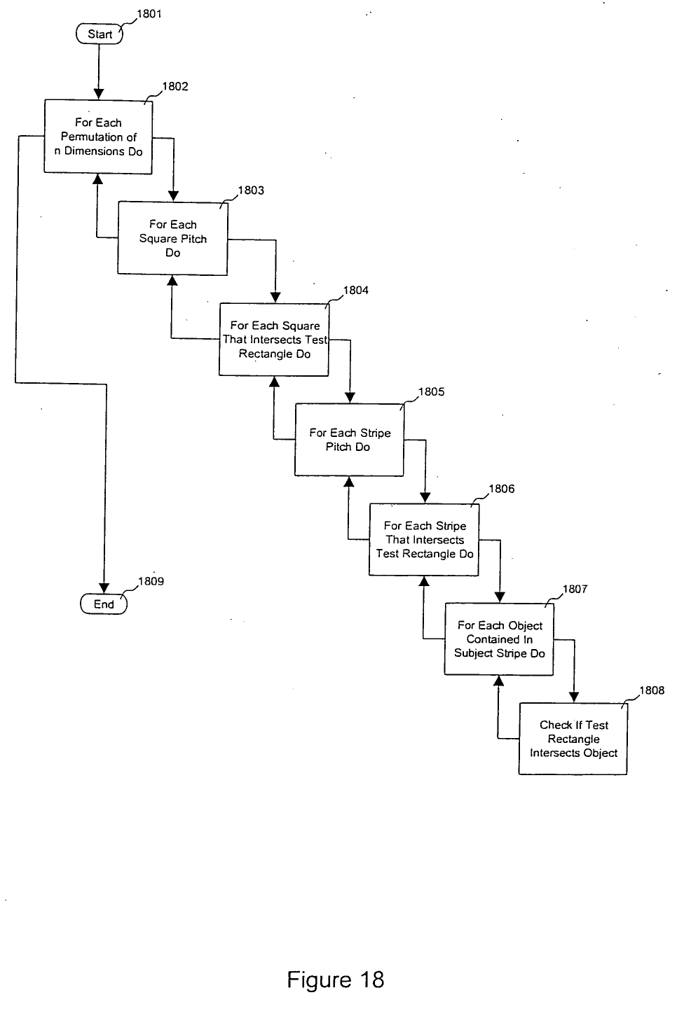

FIG. 18 is a block diagram illustrating a method adapted according to various embodiments for identifying objects stored in a data structure contained within a rectangle. Again, the example method includes a nested loop structure for traversing the data structure. Further, while a specific data structure is used in this example of a search according to various embodiments, as previously noted, alternative embodiments may employ other forms of data structures. Thus, for purposes of the present example illustration, the method starts at block 1801 and, at block 1802a “do” loop is initiated to consider each permutation of n dimensions applicable to the subject space. The top of a next loop is represented at block 1803 for addressing all pitches of squares partitioning the space. In contrast to block 1704 of the previous example for identifying a test point which would only exist in one of the squares of a particular pitch, block 1804 of the present method must identify all squares of the selected pitch intersecting the test rectangle. Block 1805 initiates traversal of all subtrees originating at squares of the selected pitch intersecting the test rectangle. Thus, stripe-type pitch selectors are implemented by blocks 1805 and 1806, wherein block 1805 sequences through each stripe pitch size, and block 1806 identifies stripes of the selected pitch that intersect the test rectangle. At block 1807 the method has identified a particular set of objects within a particular subspace and, at block 1808, each of the identified objects of the set are checked to see if the test rectangle intersects the stored object.

Other Embodiments

While various aspects and features of some embodiments have been illustrated by way of specific examples of data structures, methods of storing representations of objects and methods of searching for objects containing a point or intersecting a test object, it is to be understood that these illustrations are given by way of example only as specific embodiments. For example, other embodiments may include other combinations and permutations of partitioning a space into a plurality of subspaces including, but not limited to, mechanisms for partitioning a space based on object orientation and division of the space into symmetric and asymmetric subspaces. Further, while a hierarchical tree structure has been illustrated, other forms of data structures may be used to store representations of objects. Still further, while the present description has given examples of two- and three-dimensional spaces storing representations of objects of the same dimensionality, other embodiments are applicable to single dimensions (e.g., time lines, etc.) and multidimensional spaces including storage of objects of and less than the dimensionality of the storage space (e.g., storage of a point or a line in a multidimensional space).

1. A method of identifying objects intersecting a search window, comprising:
(i) searching each structure associated with each element of a pitch selector;
(ii) for each of said structures, searching all subspaces that intersect the search window; and
(iii) within each of said subspaces, identifying objects intersecting the search window.

2. The method of claim 1 wherein the subspaces are included within the set consisting of squares, cubes, and hypercubes.

3. The method of claim 1 wherein said i, ii, and iii are performed in the recited order.

4. The method of claim 1 wherein said objects are n-dimensional and said i and ii are performed at least n times.

5. The method of claim 4 wherein in a first performance of said i and ii the subspaces are included within the set consisting of squares, cubes, and hypercubes.

6. A computer program comprising:
a computer usable medium having computer readable program code embodied therein for identifying objects intersecting a search window, the computer readable program code in said computer program comprising:
(i) computer readable program code for causing a computer to search each structure associated with each element of a pitch selector;
(ii) computer readable program code for causing a computer to, for each of said structures, search all subspaces that intersect the search window; and
(iii) computer readable program code for causing a computer to, within each of said subspaces, identify objects intersecting the search window.

7. The computer program according to claim 6 wherein the subspaces are included within the set consisting of squares, cubes, and hypercubes.

8. The computer program according to claim 6 wherein said computer readable program code i, ii, and iii are executed in the recited order.

9. The computer program according to claim 6 wherein said objects are n-dimensional and said computer readable program code i and ii are executed at least n times.

10. The computer program according to claim 4 wherein in a first execution of said computer readable program code i and ii the subspaces are included within the set consisting of squares, cubes, and hypercubes.

11. A system for identifying objects intersecting a search window comprising:
a defined search window, which is a subspace of a space;
a plurality of objects in the space that intersect the search window;
a tree-type array with subtrees, wherein each subtree represents one of the plurality of the objects and its location in the space; and
a stripe-type pitch selector operable to traverse the tree and identify each of the plurality of objects as intersecting the search window.

12. The system of claim 11 wherein the objects are n dimensional.

13. The system of claim 1 1 wherein the search window is one of a line segment, a rectangle, a parallelepiped, or a hyperparallelepiped.

14. The system of claim 11 in which the tree-type array is a sparse array wherein memory is only allocated for portions of the space that contain one or more of the objects.

15. The system of claim 14 wherein the tree-type array includes pointers which reference each object in a computer memory.

16. The system of claim 11 wherein the stripe-type pitch selector is operable to identify a stripe pitch and a stripe number associated with each of the objects.

17. The system of claim 11 wherein the stripe-type pitch selector comprises pointers to one or more subspace arrays, and wherein the one or more subspace arrays contain pointers to corresponding subspaces of the space.
